(19) United States
(12) Patent Application Publication
(10) Pub. No.: US 2009/0287947 A1
(43) Pub. Date: Nov. 19, 2009

(54) CIRCUIT AND METHOD FOR ULTRA-LOW IDLE POWER

(75) Inventor: Richard G. DuBose, Scottsdale, AZ (US)

Correspondence Address: SNELL & WILMER L.L.P. (Main), 400 EAST VAN BUREN, ONE ARIZONA CENTER, PHOENIX, AZ, 85004-2202, US

(73) Assignee: IGO, INC., Scottsdale, AZ (US)

(21) Appl. No.: 12/465,500

(22) Filed: May 13, 2009

Related U.S. Application Data
(60) Provisional application No. 61/052,939, filed on May 13, 2008.

(51) Int. Cl. G06F 1/32

(52) U.S. Cl. 713/323

(57) ABSTRACT

A method and circuit for reducing power consumption during idle mode to ultra-low levels, such as 1/10^{th} to 1/1000^{th} of active power, is disclosed. An ultra-low idle power supply may include a primary circuit, a secondary circuit, a switch, and a feedback channel. The secondary circuit is in communication with the primary circuit, and in addition provides feedback to the primary circuit via the feedback channel. The switch receives feedback through the feedback channel and controls the state of the primary circuit. The secondary circuit monitors the output power provided to the electronic device. If the electronic device is drawing little or no power from the ultra-low idle power supply, the secondary circuit facilitates disengaging of the primary circuit. By disengaging the primary circuit, the power consumption of the ultra-low idle power supply is reduced.

### CROSS-REFERENCE TO RELATED APPLICATIONS

This applications claims priority to and benefit of U.S. Provisional Application No. 61/052,939, filed on May 13, 2008, and entitled “CIRCUIT AND METHOD FOR ULTRA-LOW IDLE POWER”, and hereby incorporated by reference.

### FIELD OF INVENTION

The present invention relates to reducing power consumption in electronic devices. More particularly, the present invention relates to a circuit and method for inducing an ultra-low idle power mode in a power supply or device.

### BACKGROUND OF THE INVENTION

The increasing demand for lower power consumption and environmentally friendly consumer devices has resulted in interest in power supply circuits with “green” technology. For example, on average, a notebook power adapter continuously “plugged in” spends 67% of its time in idle mode. Even with a power adapter which conforms to the regulatory requirements of dissipating less than 0.5 watts/hour, this extended idle time adds up to 3000 watts of wasted energy each year per adapter. When calculating the wasted energy of the numerous idle power adapters, the power lost is considerable.

### SUMMARY OF THE INVENTION

In accordance with various aspects of the present invention, a method and circuit for reducing power consumption during idle mode to ultra-low levels, such as 1/10^{th} to 1/1000^{th} of active power, is disclosed. In an exemplary embodiment, an ultra-low idle power supply provides power to an electronic device, such as for example, a notebook computer, mobile phones, Bluetooth® headsets, smartphones, MP3 players, and portable GPS systems. The ultra-low idle power supply may include a primary circuit, a secondary circuit, at least one switch, and a feedback channel. The secondary circuit is in communication with the primary circuit, and in addition provides feedback to the primary circuit via the feedback channel. The switch receives feedback through the feedback channel and controls the state of the primary circuit.

In an exemplary embodiment, the secondary circuit monitors the output power provided to the electronic device. If the electronic device is drawing little or no power from the ultra-low idle power supply, the secondary circuit communicates with at least one switch and facilitates or controls disengaging of the primary circuit. In an exemplary embodiment, such a switch is configured to control the state of the primary circuit and comprises a switching mechanism to alter the primary circuit state. By disengaging the primary circuit, the power consumption of the ultra-low idle power supply is reduced.

### BRIEF DESCRIPTION OF THE DRAWINGS

A more complete understanding of the present invention may be derived by referring to the detailed description and claims when considered in connection with the Figures, where like reference numbers refer to similar elements throughout the Figures, and:

FIG. 1 illustrates a block diagram of an exemplary power supply configured for reducing power consumption during idle mode in accordance with an exemplary embodiment;

FIG. 2 illustrates another block diagram of an exemplary power supply configured for reducing power consumption during idle mode in accordance with an exemplary embodiment; and

FIG. 3 illustrates a circuit diagram of exemplary power supply configured for reducing power consumption during idle mode in accordance with an exemplary embodiment.

### DETAILED DESCRIPTION OF EXEMPLARY EMBODIMENTS OF THE INVENTION

The present invention may be described herein in terms of various functional components and various processing steps. It should be appreciated that such functional components may be realized by any number of hardware or structural components configured to perform the specified functions. For example, the present invention may employ various integrated components, such as buffers, current mirrors, and logic devices comprised of various electrical devices, for example, resistors, transistors, capacitors, diodes and the like, whose values may be suitably configured for various intended purposes. In addition, the present invention may be practiced in any integrated circuit application. However for purposes of illustration only, exemplary embodiments of the present invention will be described herein in connection with a switching power converter for use with power supply circuits. Further, it should be noted that while various components may be suitably coupled or connected to other components within exemplary circuits, such connections and couplings can be realized by direct connection between components, or by connection through other components and devices located thereinbetween.

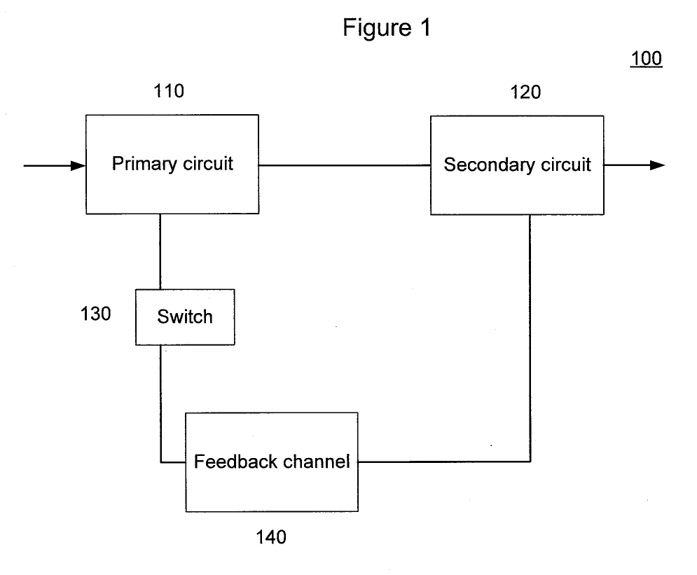

In accordance with various aspects of the present invention, a power supply configured for reducing power during idle mode to ultra-low levels, such as 1/10^{th} to 1/1000^{th} of active power is disclosed. With reference to FIG. 1, an ultra-low idle power supply 100 receives power from an outside power source and converts the power for use in an attached electronic device. In an exemplary embodiment, ultra-low idle power supply 100 comprises a primary circuit 110, a secondary circuit 120, a switch 130, and a feedback channel 140. In an exemplary embodiment, ultra-low idle power supply 100 provides power to an electronic device, such as for example, a notebook computer, mobile phones, Bluetooth® headsets, smartphones, MP3 players, and portable GPS systems. Power supply 100 may also be referred to as a power adapter, and the two terms may be used interchangeably.

In addition, the outside power source used to power ultra-low idle power supply 100 may be either alternating current (AC) or direct current (DC) and connects with primary circuit 110. Secondary circuit 120 is in communication with primary circuit 110, and in addition provides feedback to primary circuit 110 via feedback channel 140. Switch 130 receives feedback through feedback channel 140 and controls the state of primary circuit 110 and may comprise one or more switch devices.

In an exemplary embodiment, secondary circuit 120 monitors the output power provided to the electronic device. If the electronic device is drawing substantially no power from ultra-low idle power supply 100, secondary circuit 120 communicates with switch 130 and facilitates or controls disengaging of primary circuit 110. In one embodiment, substantially no power is intended to convey that the output power is in the range of 0-1% of a typical maximum output load. In an exemplary embodiment, switch 130 is configured to control the state of primary circuit 110 and comprises a switching mechanism to alter the primary circuit state. In another exemplary embodiment, secondary circuit 120 changes the modes of ultra-low idle power supply 100 in accordance with the output power level provided to the electronic device.

By substantially disabling primary circuit 110, the power consumption of ultra-low idle power supply 100 is reduced. In one embodiment, substantially disabling the primary circuit is intended to convey that primary circuit 110 switching circuits are static and drawing quiescent current only. In another embodiment, substantially disabling the primary circuit is intended to convey that switching circuits are no longer switching and that primary circuit 110 capacitors and secondary circuit 120 capacitors are static and charged with no ripple current. In yet another embodiment, substantially disabling the primary circuit is intended to convey that power is entirely removed from primary circuit 110.

In an exemplary embodiment, ultra-low idle power supply 100 has three modes: active, normal idle, and ultra-low idle. Active mode is the active functioning of ultra-low idle power supply 100 when powering an electronic device. Normal idle mode is when ultra-low idle power supply 100 is connected to an input power source but not actively powering an electronic device. In an exemplary embodiment, ultra-low idle power supply 100 verifies that the current state is idle mode prior to switching to ultra-low idle mode. The verification of the current state, in an exemplary embodiment, is made by receiving a signal indicating that no load is present from secondary circuit 120 via feedback channel 140. In another exemplary embodiment, ultra-low idle power supply 100 monitors the behavior of switching components in primary circuit 110.

During the ultra-low idle mode, primary circuit 110 is shut-off, which substantially decreases the rate of power consumption compared to during the normal idle mode. Furthermore, in another embodiment, ultra-low idle power supply 100 employs a low duty cycle “wake up” period to alter the idle time from constant idle to long periods of zero power and short periods of idle power.

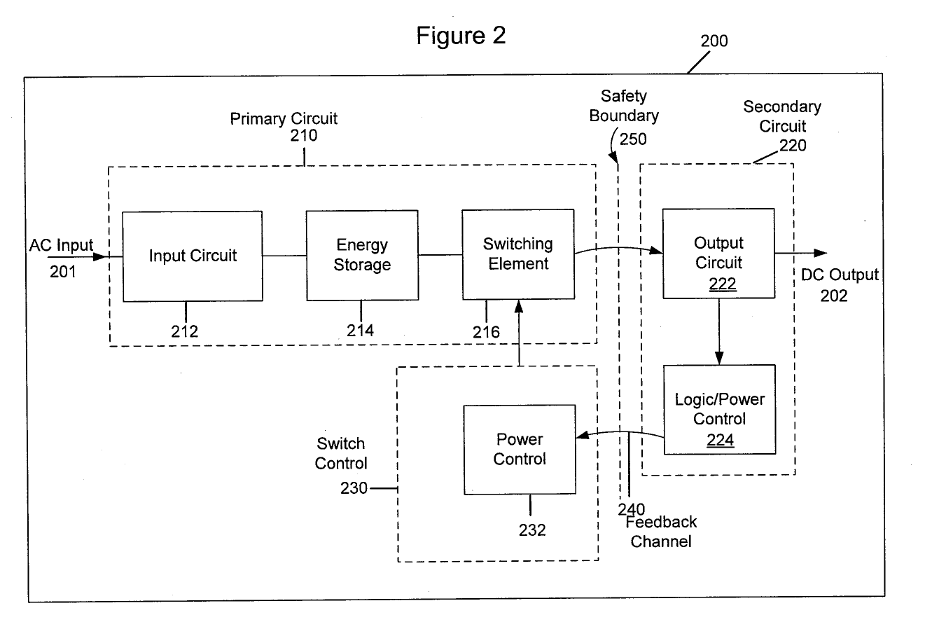

In accordance with an exemplary embodiment, and with reference to FIG. 2, an ultra-low idle power supply 200 includes a primary circuit 210, a secondary circuit 220, a switch control 230, and a feedback channel 240. A safety boundary 250 separates primary circuit 210 and secondary circuit 220. Ultra-low idle power supply 200 receives a power input 201, which can be either AC or DC, and transmits a power output 202, which can also be either AC or DC, to an electronic device.

In an exemplary embodiment, primary circuit 210 further includes an input circuit 212, an energy storage unit 214, and a switching element 216. Input circuit 212 is configured for filtering and/or rectifying input power. In one embodiment, input circuit 212 includes input EMI filters and a rectifier. Energy storage unit 214 is configured for smoothing rectified direct current and for storing energy. Furthermore, energy storage unit 214 includes an energy storage capacitor. Switching element 216 is configured for driving a dielectric isolation device, such as, for example, a transformer. In addition, in this exemplary embodiment, the switching element 216 includes a PWM controller and/or a MOSFET.

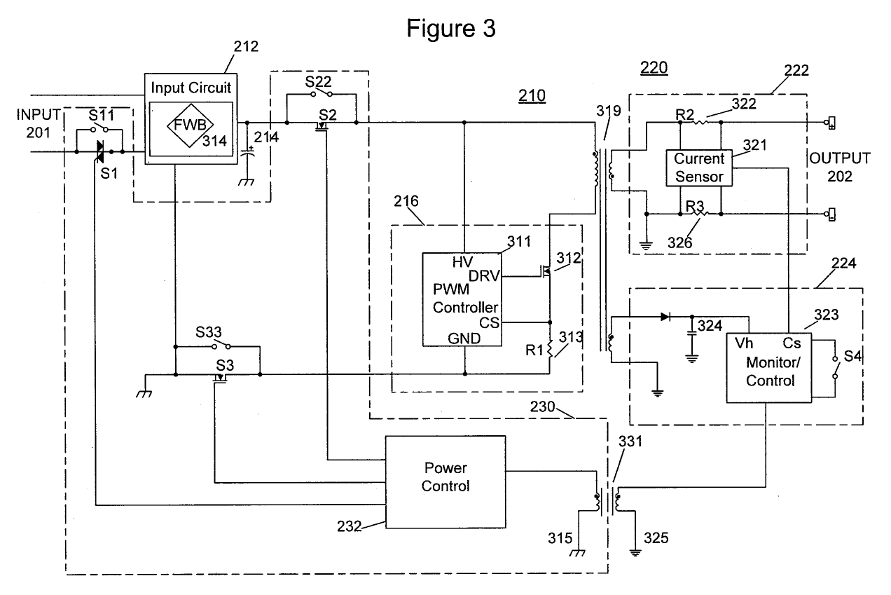

In an exemplary embodiment, and with reference to FIGS. 2 and 3, primary circuit 210 includes a pulse width modulator (PWM) 311, a MOSFET 312, a resistor R1 313, a full wave bridge circuit 314, and storage capacitor 214, and conveys power to secondary circuit 220 through a transformer 319. Furthermore, primary circuit 210 connects to a first ground 315 and secondary circuit 220 connects to a second ground 325.

In accordance with an exemplary embodiment, the power from primary circuit 210 transfers across safety boundary 250, via a transformer, to secondary circuit 220. Safety boundary 250 creates no direct contact between the primary and secondary circuits to prevent unwanted transfer of electricity. In an exemplary embodiment, safety boundary 250 includes a dielectric isolation component. The dielectric isolation component may be a transformer, a capacitive coupling, or an opto-coupler. Furthermore, the dielectric isolation component may be any component suitable to meet the criteria of safety requirement Underwriters Laboratory 60950. In accordance with safety regulations, safety boundary 250 is present in embodiments comprising AC power into primary circuit 210 and transmitting DC power from secondary circuit 220. In additional embodiments, safety boundary 250 may be present but is not required, or may not be present altogether. For example, there may not be a safety boundary in an embodiment with DC input and DC output.

In an exemplary embodiment, secondary circuit 220 further includes an output circuit 222 and a logic control unit 224. Output circuit 222 is configured to convert the power from primary circuit 210 into a desired power load at DC power output 202 for an electronic device. In an exemplary embodiment, where ultra-low idle power supply 200 receives AC power and transmits DC power, output circuit 222 includes at least one rectifier (not shown). In another exemplary embodiment, output circuit 222 includes a filter capacitor (not shown).

In accordance with an exemplary embodiment, logic control unit 224 monitors the output power delivered by ultra-low idle power supply 200 to the electronic device at power output 202. Also, logic control unit 224 controls the mode of ultra-low idle power supply 200 based on at least one of, or a combination of, the output power and/or load consumed, elapsed time between various power levels, and ambient light conditions. For example, if the output load is substantially low power for about ten seconds, then logic control unit 224 can facilitate changing ultra-low idle power supply 200 to ultra-low idle power mode. In an exemplary embodiment, power supply 200 mode is changed due to certain criteria, and the criteria can comprise a fixed criterion, a template, and/or a learned criterion. Logic control unit 224 outputs a control signal that feeds back information to primary circuit 210 via feedback channel 240. In an exemplary embodiment, logic control unit 224 includes a monitoring and control device. The monitoring and control device can comprise an analog comparator, a combinational logic machine, a state machine, and/or a microprocessor. Moreover, logic control unit 224 can comprise any suitable component for monitoring and/or controlling functions or devices.

In an exemplary embodiment, secondary circuit 220 includes a current sensor 321, a resistor R2 322, a monitor/control circuit 323, and a capacitor 324. Current sensor 321 monitors the current across resistor R2 322, which may be the point where the secondary circuit receives power from transformer 319. Current sensor 321 communicates a signal to monitor/control circuit 323 based on the monitoring. In one embodiment, the signal may be a voltage proportional to the current through current sensor 321. In another embodiment, the signal may be a current proportional to the current through current sensor 321. In another exemplary embodiment, secondary circuit 220 further comprises a resistor R3 326 connected in the ground return lead from power output 202, which may be the point where the secondary circuit current is returned from the device connected at output 202. In one embodiment, current sensor 321 monitors the current across resistor R3 326.

In addition, in an exemplary embodiment monitor/control circuit 323 is powered through capacitor 324. In another exemplary embodiment, monitor/control circuit 323 is powered by a battery. This energy source is also referred to as “housekeeping” or “hotel power”; it functions as a low auxiliary power source. If the primary circuit is shut off, this energy source may need to be occasionally charged. Once the energy source voltage is sufficiently low, the primary circuit is turned back on long enough to recharge the energy source.

Feedback channel 240 is configured to facilitate communication and/or control of switch control 230 by logic control unit 224. In an exemplary embodiment, the feedback channel 240 includes a dielectric isolation device 331, which may comprise an opto-coupler, a transformer, and/or a capacitive network. However, feedback channel 240 can comprise any other dielectric isolation device as would be known to one skilled in the art.

Switch control 230 is configured to control the state of primary circuit 210. In accordance with an exemplary embodiment, switch control 230 includes a power control unit 232. Power control unit 232, which can comprise, for example, an analog circuit, a combinational logic machine, a state machine, and/or a microprocessor, controls the operation of switching element 216. In an exemplary embodiment, power control unit 232 receives the control signal from logic control unit 224 and either enables or disables power to switch element 216. The power control signal has at least two states; normal idle and ultra-low idle. In addition, in an exemplary embodiment, switch control 230 retains its present state in memory. In one embodiment, the memory is implemented using a transistor latch. Furthermore, in an exemplary embodiment, the default unprogrammed state of the switch control is normal idle.

Additionally, in an exemplary embodiment, ultra-low idle power supply 200 further includes a physical mechanical control switch located at either the connection tip that attaches to the electronic device or at the body of the power supply itself. The control switch may be used to manually change the mode of ultra-low idle power supply 200 to the ultra-low idle power mode, or conversely, change the mode of ultra-low idle power supply 200 from ultra-low power idle mode back to active or normal idle mode.

In an exemplary embodiment, selection of the current mode is based on the historic usage of output power. A template can be designed on past usage of output power and then used to determine which mode the ultra-low idle power supply should be operating. For example, the template can determine that once the output device is in idle mode for more than 15 minutes, this usage generally means the output device will not require an active power supply for a long duration of time and the ultra-low idle power supply should switch to the ultra-low idle mode. The template may also make determinations based on at least one of time duration of power usage, time of day; day of week, and the like.

In one embodiment, ultra-low power consumption is less than 0.5 watts. However, the value may differ based on set regulatory standards. In another embodiment, ultra-low power consumption is 1/10^{th} to 1/1000^{th} or less of the active state power. For example, the power supply may consume 90 watts during active mode, 0.5 watts during idle mode, and less than 0.05 watts during ultra-low idle mode. In another embodiment, for example, the power supply consumption during normal idle mode is about 300 mW, and the power consumption during ultra-low idle mode is between about 0 mW and about 300 mW.

Such an ultra-low idle power supply circuit can be useful in various applications. For example, an ultra-low idle power supply can decrease wasted power consumption when used to power electronic devices. The ultra-low idle power supply can decrease wasted power consumption on an electronic device using an AC off-line switcher.

In addition, in an exemplary embodiment, ultra-low idle power supply 200 includes at least one illuminated indicator to show the mode of the power supply. In another embodiment, ultra-low idle power supply 200 includes a device to indicate statistics relating to power consumption. For example, the device may be a gauge, a display such as LCD or LED, and the statistics may include watts saved, power levels, efficiency of the power supply, and the like.

In accordance with an exemplary method, and with reference to FIG. 2, when the power supply is first connected to an input power source, the power adapter functions normally and responds to load conditions by supplying output power to the electronic output device. In other words, power control unit 230 initiates in the normal idle mode. Furthermore, logic control unit 224 monitors the power output conditions and determines whether the power output is lightly loaded or not loaded over some period of time. In one exemplary embodiment, ultra-low idle power supply 200 is connected to input power 201, and the power supply is in an ultra-low power idle mode until a mechanical control switch (not shown) is manually used to change the current mode from ultra-low power idle to active or normal idle mode.

Logic control unit 224 can also monitor various other conditions and characteristics. For example, in another embodiment, logic control unit 224 monitors ambient light conditions and determines whether it is dark. In yet another exemplary embodiment, logic control unit 224 monitors the behavior of switching elements 216. In another embodiment, logic control unit 224 monitors behavioral patterns of PWM 311.

In an exemplary embodiment, power supply states are changed from normal idle to ultra-low idle if the power output load is below a predetermined threshold. The predetermined threshold may be fixed, dynamic, and/or learned. In one embodiment, a light load is any power output load falling below the predetermined threshold. In an exemplary embodiment, the threshold is a certain percentage of maximum output power, such as 1% of a maximum output load. For example, a maximum output load of 90 watts would have a threshold value of 0.9 watts. The threshold may also be defined by the requirements of a regulatory body such as Energy Star that requires idle power to be less than 0.5 watts.

If a light load, or no load, is detected at the power output, logic control unit 224 will send a signal, via feedback channel 240, to power control unit 232. Once the signal is received, power control unit 232 will change states from normal idle to ultra-low idle. Furthermore, power control unit 232 transmits another control signal to switching element 216 to facilitate disabling switching element 216. Once switching element 216 is disabled, the power wasted in the switching elements is eliminated and only small leakage currents from energy storage unit 214 are lost.

In an exemplary embodiment, power control unit 232 controls at least one switch that facilitates disabling switching element 216 by interrupting the power in primary circuit 210. FIG. 3 shows switches S1, S2, and S3 in various exemplary locations. For example, switch S1 is located between the power input and input circuit 212. Switch S2 may be located between energy storage unit 214 and switching element 216. Furthermore, switch S3 may be located on a ground return in primary circuit 210. These switches may be implemented using a relay, MOSFET, triac, bipolar transistor or any other switching method as known to one skilled in the art. At least one of switches S1, S2, S3, or a combination thereof may be used to completely remove operating power from switching element 216 and cause ultra-low idle power supply 200 to enter the ultra-low power idle mode. In another exemplary embodiment, a switch S4 may be located in secondary circuit 220 to facilitate logic control unit 224 sending a signal to power control unit 232 and result in a change of state from ultra-low power idle mode to normal idle or active mode by the opening or closure of any of switches S1, S2 or S3. Although switches S1, S2, S3, and S4 are all shown in FIG. 3, in various exemplary embodiments, only one switch may be present.

Power must be restored to primary circuit 110 in order for ultra-low idle power supply 100 to operate in active or idle mode. In an exemplary embodiment and with reference to FIG. 3, any one of mechanical switches S11, S22 or S33 may be used to control the state of ultra-low idle power supply 200 changing from ultra-low power idle mode to normal idle or active mode. In an exemplary embodiment, mechanical switches S11, S22, and/or S33 are configured to supply power to switching element 216 during the mechanical switch closure. In an exemplary embodiment, at least one of switches S1, S22, and S33 is closed temporarily to effect powering ultra-low idle power supply 200. For example, switches S11, S22, and S33 may be pushbuttons operated by a user. Once power is available, switch control 230 will continue the application of power to switching element 216 from power control 232 by closing at least one of switches S1, S2 or S3. Switches S1, S2, and S3 serve as an electronic closure to persist the mechanical closure by any of switches S11, S22, or S33.

In an exemplary method, logic control unit 224 continues to monitor the output power requirements. If the load demand increases, logic control unit 224 signals power control unit 232 to change states back to normal idle mode. In another exemplary method, the energy storage components which provide power to logic control unit 224, for example capacitor 324, are monitored and if below a threshold value, logic control unit 224 signals power control unit 232 to change states to normal idle mode. The threshold value may be, for example, 10% of total energy storage capacity. Once back in normal idle mode, power is restored to logic control unit 224. The components of logic control unit 224 are then recharged, as the active components will lose power if in ultra-low idle mode. In an exemplary embodiment, power is restored to secondary circuit 220 in any manner suitable to maintain a charge on energy storage components which may be used to power logic control unit 224.

In an exemplary embodiment, logic control unit 224 may include an internal timer to periodically alter the ultra-low idle power supply state back to normal idle, so that the secondary circuit components can maintain power. In an exemplary embodiment, a timing circuit restores power to primary circuit 110. Furthermore, in an exemplary embodiment, the timing circuit operates only if ultra-low idle power supply 200 is operating in ultra-low power mode. The timing circuit can periodically energize the system by closing at least one of switches S1, S2, and S3 for brief time to facilitate recharging of secondary circuit 120. For example, power may be provided to secondary circuit 120 for a cycle time of a few seconds to a few minutes, depending on the power requirements of monitor/control circuit 323 and the capacitance size of capacitor 324.

In an exemplary embodiment, energy storage unit 214 is connected to input power 201 even when ultra-low idle power supply 200 is in the ultra-low idle mode. This results in a rapid shift from ultra-low idle mode to normal idle mode, or active mode, without the delay of recharging energy storage unit 214. In an exemplary embodiment, ultra-low idle power supply 200 is able to shift from the ultra-low idle mode in about 8 milliseconds or less. In another exemplary embodiment, the rapid shift from ultra-low idle mode occurs in less than a half cycle of AC input 201. This rapid shift occurs despite switching elements 216 being disabled during ultra-low idle mode.

The present invention has been described above with reference to various exemplary embodiments. However, those skilled in the art will recognize that changes and modifications may be made to the exemplary embodiments without departing from the scope of the present invention. For example, the various exemplary embodiments can be implemented with other types of power supply circuits in addition to the circuits illustrated above. These alternatives can be suitably selected depending upon the particular application or in consideration of any number of factors associated with the operation of the system. Moreover, these and other changes or modifications are intended to be included within the scope of the present invention, as expressed in the following claims.

1. A power supply with an ultra-low idle power mode, the power supply comprising:
a primary circuit configured to receive power from an outside power source, wherein the primary circuit is controlled in part by a switch;
a secondary circuit in communication with the primary circuit, wherein the secondary circuit monitors a power output and enables the ultra-low idle power mode in response to the power output being below a predetermined threshold; and
a feedback channel to communicate between the primary circuit and the secondary circuit;
wherein the primary circuit is substantially disabled during the ultra-low idle power mode.

2. The power supply of claim 1, wherein the predetermined threshold is one percent of a maximum power output.

3. The power supply of claim 1, wherein the switch is at least one of a mechanical switch and an electronic switch.

4. The power supply of claim 3, wherein the switch is located near at least one of the outside power source and an electronic device, and wherein the power supply provides power to the electronic device.

5. The power supply of claim 1, further comprising a monitoring and control device to facilitate monitoring of the power output.

6. The power supply of claim 5, further comprising a current sensor in the secondary circuit, wherein the monitoring and control device receives a signal from the current sensor to facilitate monitoring of the power output.

7. The power supply of claim 4, wherein the electronic device is at least one of a notebook computer, a mobile phone, a Bluetooth® headset, a smartphone, an MP3 player, and a portable GPS system.

8. A method of managing a power supply with low power consumption, the method comprising:
monitoring a power output of a secondary circuit of the power supply and detecting if substantially no load is present at the secondary circuit;
substantially disabling a primary circuit of the power supply if the substantially no load is detected; and
enabling the power supply in response to a drawn load at the power output of the secondary circuit increasing above a predetermined threshold.

9. The method of claim 8, wherein the power supply mode is at least one of active, idle, and ultra-low idle.

10. The method of claim 8, wherein the status of the power supply is at least one of on and off.

11. The method of claim 8, further comprising maintaining power to a portion of the power supply to facilitating the monitoring of the power output.

12. The method of claim 8, further comprising monitoring the elapsed time between loads present at the secondary circuit.

13. The method of claim 8, further comprising monitoring ambient light conditions surrounding the power supply.

14. A method of facilitating a power supply with low power consumption, the method comprising:
substantially disabling the power supply in response to a detected low power load; and
re-enabling the power supply with a switch to facilitate the power supply operating in an active mode.

15. The method of claim 14, wherein the status of the power supply is as least one of on and off.

16. The method of claim 14, wherein an operating mode of the power supply is controlled by the opening or closing of the switch.

17. The method of claim 14, wherein the re-enabling the power supply comprises manually operating the switch.

18. The method of claim 14, wherein the re-enabling the power supply occurs periodically.

19. A power supply comprising:
a primary circuit configured to receive a power input;
a secondary circuit coupled to the primary circuit and configured to transmit a power output to an electronic device;
a current sensor in the secondary circuit, wherein the current sensor monitors the power output; and
a feedback loop configured to transmit a control signal from the secondary circuit to the primary circuit, wherein the control signal is transmitted in response to the power output being a light load;
wherein the control signal facilitates disabling of the primary circuit.

20. The power supply of claim 19, wherein the primary circuit comprises:
an input circuit configured for filtering and rectifying an input power;
an energy storage circuit coupled to the input circuit; and
a switching element coupled to the energy storage circuit, the switching element configured for modulating the input power at a high frequency rate to drive a transformer and transfer power from a primary side of the transformer to a secondary side of the transformer.

21. The power supply of claim 20, wherein the switching element comprises a pulse width modulator controller and a MOSFET.
